(19) United States
(12) Patent Application Publication
(10) Pub. No.: US 2015/0066284 A1
(43) Pub. Date: Mar. 5, 2015

(54) AUTONOMOUS VEHICLE CONTROL FOR IMPAIRED DRIVER

(71) Applicant: Ford Global Technologies, LLC, Dearborn, MI (US)

(72) Inventor: Wilford Trent Yopp, Canton, MI (US)

(73) Assignee: Ford Global Technologies, LLC, Dearborn, MI (US)

(21) Appl. No.: 14/018,580

(22) Filed: Sep. 5, 2013

(51) Int. Cl. B60W 30/00; B60W 40/08

(52) U.S. Cl. CPC B60W 30/00; B60W 40/08; B60W 2040/0845; B60W 2540/24; B60W 2540/26
USPC 701/29.2

(57) ABSTRACT

A condition of an operator of a vehicle is detected. It is determined that the condition is an impaired condition. At least one autonomous operation is performed based on the impaired condition.

### BACKGROUND

A vehicle such as an automobile may be configured for autonomous driving operations. For example, the vehicle may include a central control unit or the like, i.e., the computing device having a processor and a memory, that receives data from various vehicle data collection devices such as sensors and generally also external data sources such as navigation information. The central control unit may then provide instructions to various vehicle components, e.g., actuators and the like that control steering, braking, acceleration, etc., to control vehicle operations without action by a human operator. Therefore, it is possible for an autonomous vehicle to operate irrespective of a state or condition of a human operator. Accordingly, there is a need for autonomous vehicles to take into account a human driver's state or condition in executing vehicle operations.

### DRAWINGS

FIG. 1 is a block diagram of an exemplary autonomous vehicle system.

FIG. 2 is a diagram of an exemplary process for detecting and responding to an impaired driver state in an autonomous vehicle.

### DETAILED DESCRIPTION

### System Overview

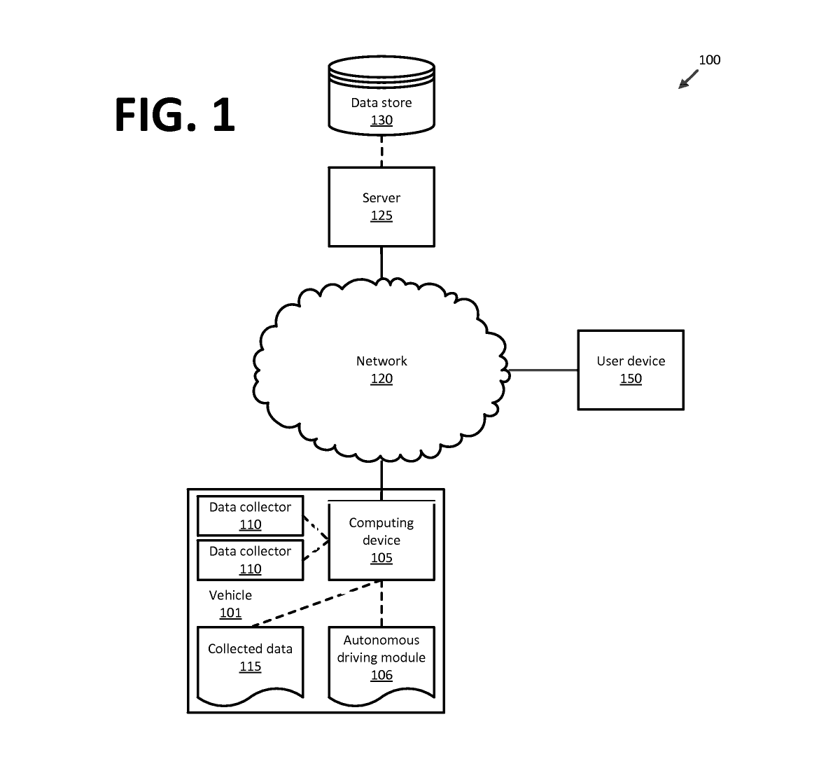

FIG. 1 is a block diagram of an exemplary autonomous vehicle system 100. A vehicle 101 includes a vehicle computer 105 that is configured to receive information, e.g., collected data 115, from one or more data collectors 110 concerning various metrics related to a vehicle operator and/or the vehicle 101. For example, such metrics may include a speed (i.e., velocity) of the vehicle 101, vehicle acceleration and/or deceleration, data related to a vehicle path or steering, biometric data related to a vehicle operator, e.g., heart rate, respiration, pupil dilation, body temperature, state of consciousness, etc. The computer 105 generally includes an autonomous driving module 106 that comprises instructions for autonomously, i.e., without operator input, operating the vehicle 101, including in response to instructions received from a server 125. The computer 105 may also include instructions for determining a vehicle operator's condition, e.g., whether the vehicle operator is impaired, and if so, how. The computer 105 may further be configured for communicating with one or more remote sites such as a server 125 via a network 120, such remote site possibly including a data store 130. The server 125 may be configured to determine, upon an impaired operator state being reported from a computer 105, what action may be taken to assist the vehicle operator, and to provide direction to the computer 105 to proceed accordingly. For example, the server 125 could direct the computer 105 to pull over to the side of the road to await assistance, or the server 125 could direct the vehicle 101 to drive in an autonomous mode to a preselected emergency health care facility, or to proceed to a rendezvous with an emergency provider such as an ambulance, etc. Each of these directives from server 125 may be based on a specific driver impairment and need for assistance. For example, in the case of a medical emergency, the server 125 could determine that it is better to have to vehicle 101 drive to a prearranged location to meet an emergency response vehicle to minimize the amount of time before medical assistance can be obtained. In another case it might be better to have the vehicle 101 drive in an autonomous mode directly to a medical assistance facility.

### Exemplary System Elements

A vehicle 101 includes a vehicle computer 105 that generally includes a processor and a memory, the memory including one or more forms of computer-readable media, and storing instructions executable by the processor for performing various operations, including as disclosed herein. Further, the computer 105 may include more than one computing device, e.g., controllers or the like included in the vehicle 101 for monitoring and/or controlling various vehicle components, e.g., an engine control unit (ECU), transmission control unit (TCU), etc. The computer 105 is generally configured for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including data collectors 110. Alternatively or additionally, in cases where the computer 105 actually comprises multiple devices, the CAN bus or the like may be used for communications between devices represented as the computer 105 in this disclosure. In addition, the computer 105 may be configured for communicating with the network 120, which, as described below, may include various wired and/or wireless networking technologies, e.g., cellular, Bluetooth, wired and/or wireless packet networks, etc.

Generally included in instructions stored in and executed by the computer 105 is an autonomous driving module 106. Using data received in the computer 105, e.g., from data collectors 110, the server 125, etc., the module 106 may control various vehicle 101 components and/or operations without a driver to operate the vehicle 101. For example, the module 106 may be used to regulate vehicle 101 speed, acceleration, deceleration, steering, operation of components such as lights, windshield wipers, etc.

Data collectors 110 may include a variety of devices. For example, various controllers in a vehicle may operate as data collectors 110 to provide data 115 via the CAN bus, e.g., data 115 relating to vehicle speed, acceleration, etc. Further, sensors or the like, global positioning system (GPS) equipment, etc., could be included in a vehicle and configured as data collectors 110 to provide data directly to the computer 105, e.g., via a wired or wireless connection. Sensor data collectors 110 could include mechanisms such as RADAR, LADAR, sonar, etc. sensors that could be deployed to measure a distance between the vehicle 101 and other vehicles or objects. Yet other sensor data collectors 110 could include cameras, breathalyzers, motion detectors, etc., i.e., data collectors 110 to provide data for evaluating a condition or state of a vehicle 101 operator.

A memory of the computer 105 generally stores collected data 115. Collected data 115 may include a variety of data collected in a vehicle 101. Examples of collected data 115 are provided above, and moreover, data 115 is generally collected using one or more data collectors 110, and may additionally include data calculated therefrom in the computer 105, and/or at the server 125. In general, collected data 115 may include any data that may be gathered by a collection device 110 and/or computed from such data.

The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various steps and processes described herein. The server 125 may include or be communicatively coupled to a data store 130 for storing collected data 115, records relating to potential incidents generated as described herein, etc. Further, the server 125 may store information related to multiple vehicles 101, traffic conditions, weather conditions, etc., within a geographic area, with respect to a particular road, city, etc. Moreover, the server 125 could be configured to store information related to health care facility locations and/or current locations of mobile health care assistance vehicles and their respective availabilities to respond to a new request for assistance. The server 125 could also be configured to provide drive-by-wire instructions to vehicles 101 in an autonomous driving area, e.g., a road, etc., such as an “all stop” instruction for all vehicles 101 to stop, a speed restriction, a lane restriction, etc.

A user device 150 may be any one of a variety of computing devices including a processor and a memory, as well as communication capabilities. For example, the user device 150 may be a portable computer, tablet computer, a smart phone, etc. that includes capabilities for wireless communications using IEEE 802.11, Bluetooth, and/or cellular communications protocols. Further, the user device 155 may use such communication capabilities to communicate via the network 120 and also directly with a vehicle computer 105, e.g., using Bluetooth.

### Exemplary Process Flows

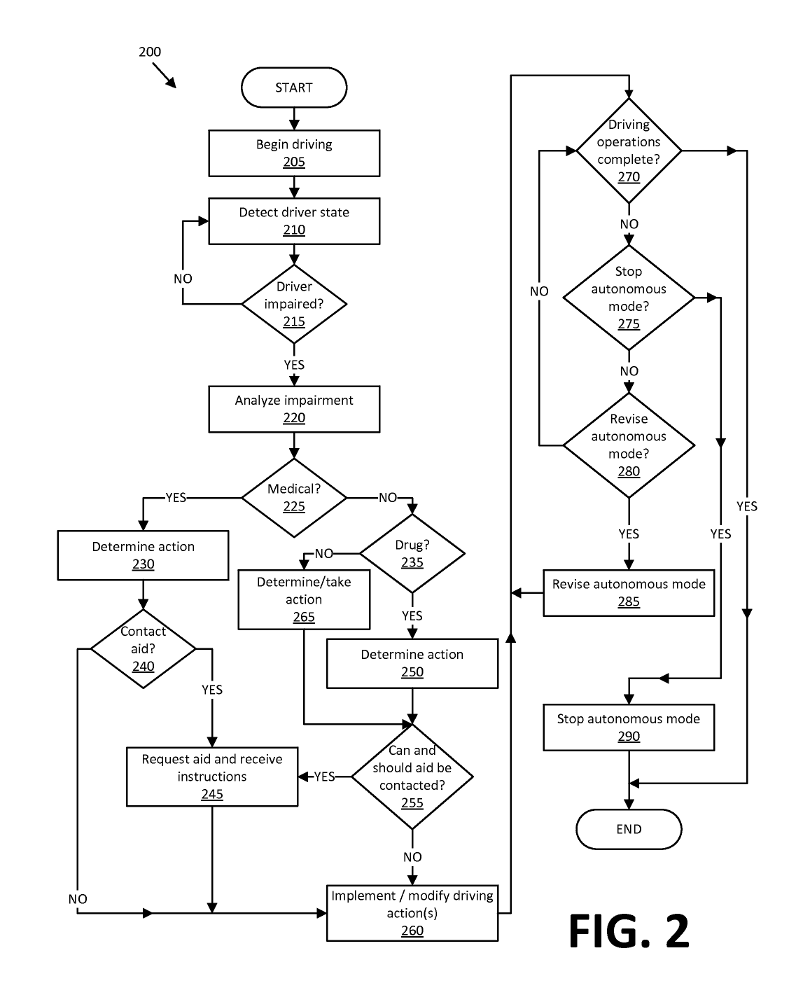

FIG. 2 is a diagram of an exemplary process 200 for detecting and responding to an impaired driver state in an autonomous, vehicle.

The process 200 begins in a block 205, in which a vehicle 101 commences driving operations, which could be manually controlled by a vehicle driver, or which could be partially or completely autonomous. For example, as mentioned above, the computer 105 could be configured to control operation of the vehicle 101 based on collected data 115 and/or instructions from the server 125. However, it is also possible that, in the block 205, the vehicle 101 may be manually driven by a driver, or some operations, e.g., braking, could be manually controlled by a driver, while other operations, e.g., steering, could be controlled by the computer 105.

Next, in a block 210, the computer 105 examines a state of a vehicle 101 operator, e.g., driver. For example, as mentioned above, the computer 105 could use various sensor data collectors 110 to obtain data 115 showing an image of the driver, measuring respiration, pulse rate, etc., and could use various known mechanisms for detecting driver impairment.

Next, in a block 215, the computer 105 determines whether a driver impairment state has been detected. For example, collected data 115 relating to a driver state could be used to establish parameters for driver impairment, whereupon data 115, by itself or in combination with other collected data 115, could indicate driver impairment when outside establish parameters. If no driver impairment is detected, the process 200 returns to the block 210. However, if driver impairment is detected, then the process 200 proceeds to a block 220.

In the block 220, the computer 105 further analyzes the data 115 to determine a specific type of driver impairment in the block 215. For example, certain data 115 values could indicate a likelihood of one or more various types of driver impairment, such as a medical condition, e.g., a heart attack, the influence of alcohol and/or drugs, the driver has fallen asleep at the wheel, etc. In general, a variety of known mechanisms may be used to detect a driver impairment and to analyze and determine a type of impairment.

Accordingly, in a block 225, following the block 220, the computer 105 determines whether a medical condition has been detected. A medical condition could be indicated according to the analysis of the block 220 if data 115 values provide an indication that a driver's pulse rate, body temperature, respiration, etc. are outside of predetermined ranges, if a driver's eyes are dilated, etc. Further, the computer 105 and/or a user device 150 in communication with the computer 105 could be configured to determine whether a driver is able to respond to a question or questions from a human machine interface (HMI) or the like, and/or an HMI or the like could be used to obtain information from a driver concerning a driver condition, e.g., an impaired condition. If a medical condition is detected, then a block 230 is executed next. Otherwise, the process 200 proceeds to a block 235.

If a medical condition is detected in the block 225, then in the block 230, the autonomous driving module 106 determines whether the computer 105 is able to communicate with the server 125 and/or an emergency assistance provider to request assistance for the medical condition. The computer 105 may make such determination via a variety of mechanisms. For example, the computer 105 could send a test message or the like to determine whether communication with the server 125 and/or an assistance provider is possible. Further for example, if the computer 105 is not able to contact the network 120, then the computer 105 will determine that it is not possible to call for assistance. Moreover, the computer 105 may contact the server 125 via the network 120 to determine whether assistance may be available. The server 125, or the computer 105, may determine that it is not possible to obtain assistance due to a location of the vehicle 101 or some other factor.

Following the block 230, in a block 240, the computer 105 determines whether an ability to request assistance was established in the block 230. If so, a block 245 (discussed below) is executed next. Otherwise, the process 200 proceeds to a block 260.

If a medical condition is not detected in the block 225, then in a block 235, the computer 105 determines whether a vehicle 101 driver has been detected to be under the influence of a drug, e.g., alcohol, a narcotic, etc. For example, a vehicle driver could provide a sample to a breathalyzer connected to the computer 101, data collectors 110 in the vehicle 101 could provide data, e.g., speech analysis, analysis of images showing eye dilation, skin color, etc., to determine that a vehicle 101 driver was under the influence of a drug. If a drug condition is detected, then a block 250 is executed next. Otherwise, in the event that the computer 105 is unable to identify a specific cause of a driver's impairment, the process 200 proceeds to a block 265.

In the block 250, a drug condition having been detected, then, such as described with respect to the block 230, the computer 105 evaluates whether there is a need to communicate with the server 125 and/or an emergency assistance provider to request assistance for the drug condition.

In the block 255, which may follow the block 250 or the block 265, the computer 105 determines not only whether it has been determined in the block 250 that assistance or aid may be contacted, but also whether an entity that may provide assistance, e.g., a call center provider such as a hospital, a “911” call center, a vehicle assistance service, etc., should be contacted. For example, some drug impairments may require assistance, e.g., where a driver is comatose or experiencing a life-threatening reaction. On the other hand, if the driver does not require assistance but is merely impaired, e.g., under the influence of alcohol or some other drug, the autonomous driving module 106 may be employed to safely deliver the driver to his or her destination, particularly if other measures are taken, such as disabling any ability of the driver to override the module 106 and take control of the vehicle 101. If aid can and should be contacted, then the process 200 proceeds to the block 245, discussed below. Otherwise, the process 200 proceeds to the block 260.

In the block 245, which may follow the block 240 or the block 255 as described above, the computer 105 provides a request to the server 125 for aid, i.e. assistance, for the vehicle 101. This request may be provided in a variety of ways. For example, the computer 105 could contact a call center directly, e.g., via a cellular network or the like. Alternatively or additionally, the computer 105 could submit a request to the server 125, which then in turn could include instructions for obtaining assistance. In any event, once a request for assistance is made, the computer 105 generally receives instructions from an entity that was queried, e.g., the server 125, a call center, etc., concerning operations to be performed by the autonomous driving module 106. For example, such instructions could be provided in a predetermined format, e.g., providing a driving route and other driving instructions, etc., e.g., based on a need of assistance and urgency of the need. The instruction may also take into account a vehicle's autonomous driving capability, e.g., whether the vehicle supports autonomous driving operations.

In a block 260, which may follow the block 245, or the block 255, the autonomous driving module 106 implements appropriate driving instructions. For example, if the block 260 follows the block 255, this means that a driver has been determined to have a drug impairment, but it is not necessary to request assistance outside the vehicle 101 or that contact with the server 125 was not possible at the present time. Accordingly, the driving module 106 could be configured to implement driving instructions such that the driver is not permitted to take control of vehicle operations and/or to switch from manual to fully autonomous driving, and the driving module 106 could further implement instructions to proceed to a safe location, e.g., the driver's residence, office, a hospital, etc. Further, if the block 260 follows the block 245, the autonomous driving module 106 may implement driving instructions set forth by an entity providing assistance, e.g., to pull over by the side of the road or in a parking lot to await aid, to rendezvous with emergency vehicles at a specified location, to proceed to a hospital, etc.

Alternatively or additionally to following instructions received in response to a request for aid as described with respect to the block 245, even if aid has not been requested as described in the block 245, the module 106 may implement one or more driving actions in the block 260. This action may include implementing partial or complete autonomous driving if the vehicle 101 is currently in a manual, or partially autonomous, driving mode. For example, if a driver is determined to be unconscious, unresponsive, etc., the module 106 could execute instructions to maneuver the vehicle 101 to a stop at a side of the road. Further for example, the module 106 could execute instructions to drive the vehicle 101 to a safe location, e.g., off of a highway, to a well-lighted parking lot, etc., and then stopped to await aid. Alternatively, the vehicle 101 could be instructed to continue driving.

A block 265 may follow the block 235. If the process 200 reaches the block 265, this means that a driver impairment has been detected, but the impairment has not been determined to be a medical impairment or a drug impairment, such as the driver has become drowsy or fallen asleep. Following the block 265, the process 200 proceeds to the block 255.

In a block 270, which follows the block 260, the computer 105 determines whether driving operations are complete, i.e., whether the autonomous driving module 106 has further operations to conduct, e.g., because the vehicle 101 has not reached a specified destination, e.g., a destination specified by any provider, determined by the computer 105 in response to driver impairment, etc. If driving operations are complete, the process 200 ends. Otherwise, a block 275 is executed next.

In the block 275, the computer 105 determines whether to stop a partial or complete autonomous driving mode, e.g., operations of the autonomous driving module 106 that may have been implemented as described above. For example, unless a driver's impairment has resulted in the driver's ability to override the module 106 being revoked, the driver may provide input to stop the module 106. Further, the server 125 or some other element of an autonomous driving infrastructure could provide an instruction to the computer 105 to cease autonomous driving operations. For example, the vehicle 101 could be ordered to stop due to the driver's condition, due to road conditions, weather conditions, etc. In any event, if the computer 105 determines to stop the autonomous driving mode, then the process 200 proceeds to a block 290. Otherwise, a block 280 is executed next.

In the block 280, the computer 105 determines whether any revisions to the autonomous driving mode, e.g., to operations being performed by the module 106, should be made. For example, the computer 105 could receive instructions from the server 125 or some other element of an autonomous driving infrastructure to modify a route, e.g., because of weather conditions, road conditions, etc., or because an emergency vehicle or entity rendering roadside aid has changed its route or availability. If the autonomous driving mode should be revised, the process 200 proceeds to a block 285. Otherwise, the process 200 returns to the block 270.

In the block 285, appropriate revisions, e.g., revisions as determined in the block 280, are made to the autonomous driving mode. The process 200 then returns to the block 270.

In the block 290, which may follow the block 270, the autonomous driving mode is stopped, e.g., the computer 105 ceases operations of the module 106. Following the block 290, the process 200 ends.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer in a vehicle, the computer comprising a processor and a memory, wherein the computer is configured to:
detect a condition of an operator of the vehicle;
determine that the condition is an impaired condition; and
perform at least one autonomous operation based on the impaired condition.

2. The system of claim 1, wherein the autonomous operation includes requesting assistance, based on the impaired condition, from an entity outside the vehicle.

3. The system of claim 2, wherein the computer is further configured to receive a response to the request, and to perform the autonomous operation based on the response.

4. The system of claim 3, wherein the computer is further configured to receive an additional instruction from the outside entity following the response, and to perform a second autonomous operation based on the additional instruction.

5. The system of claim 1, wherein the autonomous operation is one of continuing with a driving route, stopping the vehicle, and proceeding to a specified location.

6. The system of claim 1, wherein the impaired condition is one of a medical condition and a drug-related condition.

7. The system of claim 1, wherein the computer is configured to determine that the condition is an impaired condition based at least in part on input obtained via a human machine interface (HMI).

8. The system of claim 1, wherein the computer is configured to determine that the condition is an impaired condition based at least in part on input obtained from one or more sensors in the vehicle that gather data without human input.

9. A method, comprising:
detect a condition of an operator of a vehicle;
determine that the condition is an impaired condition; and
perform at least one autonomous operation based on the impaired condition.

10. The method of claim 9, wherein the autonomous operation includes requesting assistance, based on the impaired condition, from an entity outside the vehicle.

11. The method of claim 10, further comprising receiving a response to the request, and performing the autonomous operation based on the response.

12. The method of claim 11, further comprising receiving an additional instruction from the outside entity following the response, and performing a second autonomous operation based on the additional instruction.

13. The method of claim 9, wherein the autonomous operation is one of continuing with a driving route, stopping the vehicle, and proceeding to a specified location.

14. The method of claim 9, wherein the impaired condition is one of a medical condition and a drug-related condition.

15. The method of claim 9, further comprising determining that the condition is an impaired condition based at least in part on input obtained via a human machine interface (HMI).

16. The method of claim 9, further comprising determining that the condition is an impaired condition based at least in part on input obtained from one or more sensors in the vehicle that gather data without human input.

17. A system, comprising a computer in a vehicle, the computer comprising a processor and a memory, wherein the computer is configured to:
detect a condition of an operator of the vehicle;
determine that the condition is an impaired condition;
request assistance, based on the impaired condition, from an entity outside the vehicle;
receive an instruction for autonomous driving in response to the request; and
perform an autonomous driving operation based on the instruction.

18. The system of claim 17, wherein the impaired condition is one of a medical condition and a drug-related condition.

19. The system of claim 17, wherein the computer is configured to determine that the condition is an impaired condition based at least in part on input obtained via a human machine interface (HMI).

20. The system of claim 17, wherein the computer is configured to determine that the condition is an impaired condition based at least in part on input obtained from one or more sensors in the vehicle that gather data without human input.

21. The system of claim 17, wherein the instruction is based on an ability of the vehicle to operate autonomously, a need of assistance and urgency of the need.
